(19) United States
(12) Patent Application Publication
(10) Pub. No.: US 2010/0223320 A1
(43) Pub. Date: Sep. 2, 2010

(54) DATA DISTRIBUTION EFFICIENCY FOR ONLINE COLLABORATIVE COMPUTING SESSIONS

(76) Inventors: He Huang, San Jose, CA (US); Jian Lin, Pleasant Hill, CA (US); Zheng Yuan, San Jose, CA (US); Defeng Lu, San Jose, CA (US)

Correspondence Address: CESARI AND MCKENNA, LLP, 88 BLACK FALCON AVENUE, BOSTON, MA, 02210, US

(21) Appl. No.: 12/394,257

(22) Filed: Feb. 27, 2009

(51) Int. Cl. G06F 15/16

(52) U.S. Cl. 709/203; 709/205

(57) ABSTRACT

In one embodiment, an online collaborative computing session is initiated between a presenter device and a plurality of attendee devices via a server in a computer network. The server distributes session data from the presenter device to the plurality of attendee devices. To decrease the amount of traffic in the network, at least one of the plurality of attendee devices may be selected as a super node, where each super node is then responsible for one or more corresponding attendee devices of the session. The session data is received at the super nodes and distributed from the super node to its one or more corresponding attendee devices.

### TECHNICAL FIELD

The present disclosure relates generally to computer networks, and, more particularly, to online collaborative computing sessions.

### BACKGROUND

Online collaborative computing sessions, such as interactive conferences (e.g., web conferences/meetings), may be supported by a computer network having one or more servers distributing content between participating client computers. In particular, one or more participants, e.g., hosts and/or attendees, may join a session from their client computers through an access point to the servers, such as a web page. Subsequently, data/content originated by the host/presenter is then distributed to the attendees of the session. When there are a large number of participants in the session, the servers are required to send the same copy of the data to each participant, thus resulting in increased traffic through the computer network that consumes network resources.

### BRIEF DESCRIPTION OF THE DRAWINGS

The advantages of the invention may be better understood by referring to the following description in conjunction with the accompanying drawings in which like reference numerals indicate identically or functionally similar elements, of which:

FIG. 1 illustrates an example computer network;

FIG. 2 illustrates an example device/node;

FIG. 3 illustrates an example server arrangement;

FIGS. 4A-6B illustrate example sessions and data distribution between devices/nodes in a network; and

FIG. 7 illustrates an example procedure for data distribution efficiency for online collaborative computing sessions.

### DESCRIPTION OF EXAMPLE EMBODIMENTS

### Overview

According to embodiments of the disclosure, an online collaborative computing session is initiated between a presenter device and a plurality of attendee devices via a server in a computer network. The server distributes session data from the presenter device to the plurality of attendee devices. To decrease the amount of traffic in the network, at least one of the plurality of attendee devices may be selected as a super node, where each super node is then responsible for one or more corresponding attendee devices of the session. The session data is received at the super nodes and distributed from the super node to its one or more corresponding attendee devices.

### DESCRIPTION

Architecture for Collaborative Computing Sessions

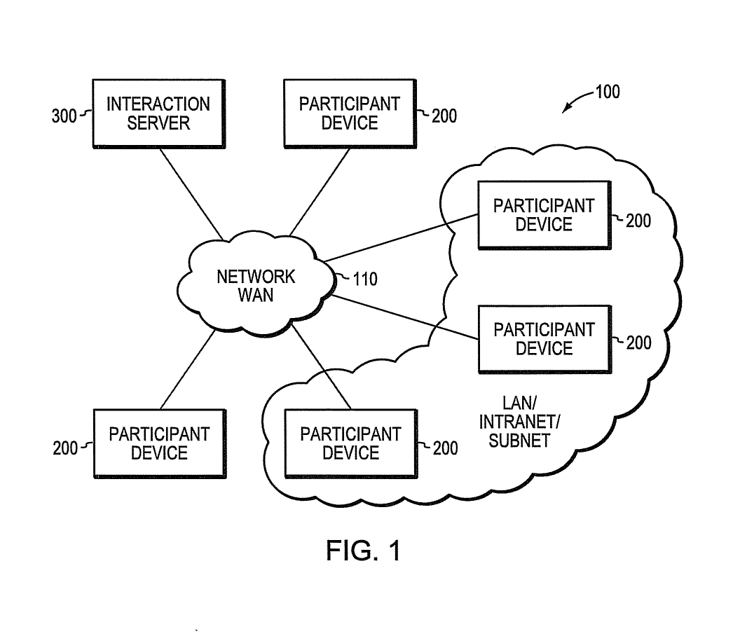

FIG. 1 is a schematic block diagram of an example computer network 100 illustratively comprising nodes/devices, such as one or more participant devices 200 and one or more interaction servers 300 interconnected by links/network 110 as shown and as described further herein. For instance, participant devices, as described below, may be a personal computer (PC) or one or more peripheral devices, such as phones, pagers, etc. Those skilled in the art will understand that any number of nodes, devices, links, etc. may be used in the computer network, and that the view shown herein is for simplicity.

In this environment, a number of participants may interact in an online, interactive, or collaborative setting. Such a setting can be for a meeting, training or education, support, or any other event that may require a number of participants to work together, interact, collaborate, or otherwise participate, such as web conferences, online meetings, etc. As used herein, the phrase “collaborative computing session” may be used to describe these settings/events, particularly where a number of participant computers/devices collaborate in an established session, as may be appreciated by those skilled in the art. Also, as used herein, a “session” describes a generally lasting communication between one or more participant devices 200 through the interaction server 300. Those skilled in the art will understand that the session may be implemented/established using protocols and services provided by various layers (e.g., application, session, and/or transport layers) of a network protocol stack according to the well-known OSI model. Conversely, a “meeting” describes a personal layer of communication overlaid upon the session where participants/users communicate with each other. Moreover, while the terms “session” and “meeting” may generally be used interchangeably herein to denote a collaboration of people or devices, particular instances of their use may denote a particular distinction (e.g., a session may start with attendees joining/connecting to the servers, while a meeting may not start until a host/presenter joins the session), as may be understood by those skilled in the art.

In other words, a collaboration session comprises a plurality of devices or “participant devices,” of which “attendee devices” are configured to view/receive content submitted or “shared” by “presenter devices.” In some instances, the attendee devices are capable of modifying the content shared by the presenter device. (Further, the presenter device may also be an attendee device, and visa versa.)

In particular, each participant (e.g., hosts/presenters and/or attendees) may operate a participant device 200. Each participant device 200 may comprise an electronic device with capability for visual and/or auditory presentation. Thus, a participant device 200 can be, for example, a desktop personal computer (PC), a laptop computer, a workstation, a personal digital assistant (PDA), a wireless telephone, a smart phone, an Internet television, and the like. Each participant device 200 supports communication by a respective participant, in the form of suitable input device (e.g., keyboard, mouse, stylus, keypad, etc.) and output device (e.g., monitor, display, speech, voice, or other device supporting the presentation of audible/visual information). Each participant device may be interconnected with a suitable communications network 110 such as, for example, the Internet, and may appear as a client computer thereon.

In one embodiment, each participant device 200 may operate under the control of a suitable operating system (OS) (e.g., WINDOWS, UNIX, etc.) to run software applications (e.g., in the form of code modules) which may be installed, received, or downloaded. At least some of these software applications may support specific functions, such as, for example, functions related to the online, interactive meeting (a collaborative computing session), such as conventional web browser programs that allow convenient access and navigation of the Internet (e.g., the World Wide Web).

The online meeting (collaborative computing session) of the various participants may be supported by an interaction server 300 which may be maintained or operated by one or more of the participants and/or a third-party service provider. The interaction server 300 may be a computer system that is connected to network 110, and which may comprise and appear as one or more server computers thereon. Interaction server 300 may store information (e.g., content) and application modules which can be provided to the participant devices 200. In some embodiments, these application modules are downloadable to the participant devices 200 and may support various functions that may be required for an interactive meeting or collaborative effort among the participants. The participant devices 200 and the interaction server 300 may interact in a client/server architecture, which may provide high performance and security for a multi-participant collaborative environment.

Network 110 may comprise or be supported by one or more suitable communication networks, such as, for example, a telecommunications network that allows communication via one or more telecommunications lines/channels. In particular, the communication or data networks, such as the Internet, may be used to deliver content, such as for the collaborative computing sessions herein. The Internet is an interconnection of computer clients and servers located throughout the world and exchanging information according to Transmission Control Protocol/Internet Protocol (TCP/IP), Internetwork Packet eXchange/Sequence Packet eXchange (IPX/SPX), AppleTalk, or other suitable protocol. The Internet supports the distributed application known as the “World Wide Web.” Web servers maintain websites, each comprising one or more web pages at which information is made available for viewing and audio/hearing. Each website or web page may be supported by documents formatted in any suitable conventional markup language (e.g., HTML or XML). Information may be communicated from a web server to a client using a suitable protocol, such as, for example, Hypertext Transfer Protocol (HTTP) or File Transfer Protocol (FTP).

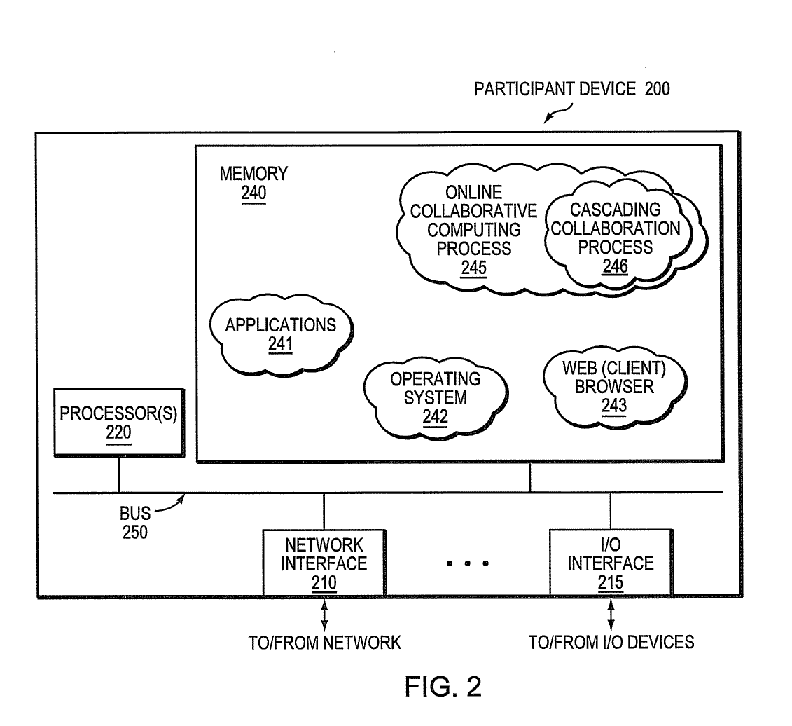

FIG. 2 illustrates a schematic block diagram of an example participant device 200 that may be advantageously used with one or more embodiments described herein, e.g., for collaborative computing. Illustratively, device 200 may be implemented or incorporated in any suitable computer such as, for example, a personal computer (PC), laptop, workstation, personal digital assistant (PDA), smart phone, mainframe, file server, workstation, or other suitable data processing facility supported by storage (either internal, e.g., electronic memory, or external, e.g., magnetic/optical disk), and operating under the control of any suitable OS.

In particular, the device 200 comprises one or more network interfaces 210, one or more input/output (I/O) interfaces 215, one or more processors 220, and a memory 240 interconnected by a system bus 250. The network interfaces 210 contain the mechanical, electrical, and signaling circuitry for communicating data over physical/wireless links coupled to the network 110. The network interface(s) may be configured to transmit and/or receive data using a variety of different communication protocols suitable for the network. Also, I/O interfaces 215 contain the mechanical, electrical, and signaling circuitry for communicating with one or more user interface devices, such as a mouse, keyboard, monitor/screen, etc. (not explicitly shown).

The memory 240 comprises a plurality of storage locations that are addressable by the processor(s) 220 and the network interfaces 210 for storing software programs associated with the embodiments described herein. A portion of the memory may (though need not) be arranged as a cache (not shown) configured to store one or more data structures and/or code modules associated with embodiments described herein. The processor(s) 220 may comprise necessary elements or logic adapted to execute the software programs and manipulate the data structures. An operating system 242, portions of which are typically resident in memory 240 and executed by the processor(s), functionally organizes the device by, inter alia, invoking operations in support of software processes and/or services executing on the device (e.g., for collaborative computing sessions as used herein). In particular, these software processes and/or services may comprise one or more applications 241 (e.g., web browser 243) as understood by those skilled in the art, and, in particular, an online collaborative computing process 245 and a cascading collaboration process 246, as described herein. It will be apparent to those skilled in the art that other types of processors and memory, including various computer-readable media, may be used to store and execute program instructions pertaining to the inventive technique described herein.

The online collaborative computing process 245 may contain computer executable instructions executed by the processors 220 to generally perform functions to manage or control various processes or aspects during the course of an online meeting or collaborative computing session in which the participant (user) may interact with other users. For instance, an activity manager may manage meeting-related actions (e.g., starting a session, ending a session, locking a session, etc.), manage participant-related actions (e.g., designating a participant as a session host, assigning a participant the presenter privileges, expelling a participant, establishing participant privileges, etc.), manage session-related actions (e.g., starting a sharing session, closing a sharing session, setting privileges within that sharing session, etc.), and support an interface with the user or participant, and provide a container for embedding one or more application code modules.

Also, a communications component of process 245 may support communication between system 200 and an outside network 110 (e.g., the Internet), such as through network interfaces 210. The communications component thus allows data and information to be exchanged with or retrieved from other systems or facilities (e.g., participant devices 200 or interaction server 300), for example, during an online meeting or other collaborative computing session. In particular, the communications component may provide a communication platform for any one or more process instances of process 245. For instance, the activity manager may rely on the communications component to establish and maintain the client connection to the interaction server 300 on which the activity session is hosted. Any application code modules (not shown) may also use the established client connection to provide real-time data that is sent and received by each participant.

Various functionality for supporting a collaborative computing session, such as an online meeting, may be provided by the one or more application code modules, generally described herein as being components of the online collaborative computing process 245. These application code modules may be stored/maintained (e.g., by a cache), and may support, for example, basic communication framework, file sharing (e.g., for text, images, video, audio), user authentication, meeting scheduling, address book, files and folders, invoices, billing, scheduling, telephone or video conferencing, authentication, database management, word processing, application sharing, accounting, etc. For example, code modules may comprise (not specifically shown) a text-based chat module, a polling module, a video module, a voice over Internet Protocol (VOIP) module, a question-answer (QA) module, a file transfer module, a presentation module, an application/desktop view/share module, and an Internet telephony module.

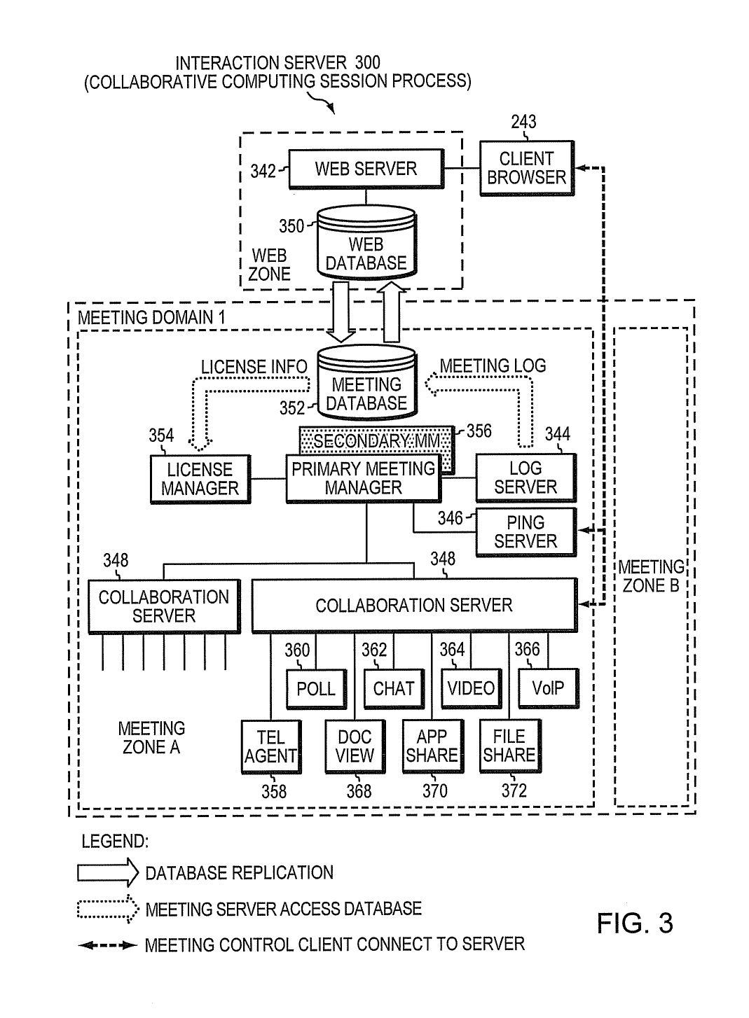

FIG. 3 illustrates an example implementation for a computer system that may operate as interaction server 300 according to one or more embodiments described herein. Illustratively, in the computer system environment as shown, a number of server computers and databases may be in communication to provide for collaborative meeting or computing. As such, the interaction server 300 and its various components may be referred to as a collaborative computing process 300. (Illustrative details for such a computer system environment may be found in commonly-owned, copending U.S. patent application Ser. No. 09/751,424 entitled “DISTRIBUTED NETWORK SYSTEM ARCHITECTURE FOR COLLABORATIVE COMPUTING,” filed on Dec. 29, 2000, by Zhu et al., now published as U.S. patent application Publication 2003/0167301 on Sep. 4, 2003.) Notably, while the illustrative embodiment described below shows a collection of servers (e.g., localized and/or distributed), a single server may also operate to perform the functions described herein (e.g., collaborative computing process 300). Thus, “interaction server 300” may comprise, either as a single server or as a collection of servers, one or more memories, one or more processors, one or more network interfaces (e.g., adapted to communicate traffic for a collaborative computing session and also traffic on a communication channel other than the collaborative computing session), etc., as may be appreciated by those skilled in the art.

In particular, referring to the environment shown in FIG. 3, a number of processing facilities, including, for example, one or more of a web server 342, a log server 344, a ping server 346, a collaboration server 348, license manager 354, primary and secondary meeting managers 356, application servers (e.g. telephone agent 358, poll 360, chat 362, video 364, voice over IP 366, document view 368, application share 370, and file share 372) may be integrated with a number of data storage facilities, such as, for example, a web database 350 and a meeting database 352 to implement a system for collaborative meetings over the Internet (e.g., for collaborative computing session “process” 300). As depicted, the processing and database facilities of this environment (“process” 300) may be divided into a web zone and one or more meeting zones for interaction with one or more client browsers (which may operate on respective participant devices 200).

A web zone may comprise one or more server machines that share a common web database 350. In the web zone, web server 342 may have a unique IP address (which may be associated with a particular website) and may respond to, e.g., Hyper-Text Transport Protocol (HTTP) requests coming to that IP address from client browser 243. Web server 342 serves or supports web pages, while web database 350 may contain static information for the website including site specific data, web pages, and user data.

Illustratively, a meeting zone is a collection of servers and databases that help perform synchronous activity of an online collaborative meeting. In a meeting zone, the meeting managers 356 may be servers which communicate with other servers in the meeting zone (e.g., collaboration server 348, log server 344, ping server 346, etc.) to keep track of the online meetings in progress in the meeting zone. Meeting managers 356 may log meeting information into meeting database 352. Ping server 346 works with meeting managers 356 to determine a collaboration server 348 that is most suitable for hosting a particular meeting; it may act as a load balancer for the meeting service. Collaboration servers 348 may handle all real time control and communication during an online collaborative meeting. The application servers (e.g., servers 358 through 372) may support specific features that may be available as part of an online collaborative meeting, such as, for example, telephony, polling, chatting, video, voice over IP, document review, application sharing, and file sharing (e.g., “sub-sessions”). Also, license manager 354 may keep track of and enforce licensing conditions and charges for the meeting. Further, the log server 344 may keep track of meeting logs, and meeting database 352 may maintain at least a portion of the transient data required to conduct and keep track of online meetings. This data may include, for example, site and user information that would be required to establish and conduct a meeting.

As noted above, online collaborative computing sessions generally transmit data (e.g., voice, video, files, images, etc.) from one or more presenter devices to a plurality of attendee devices via server(s) 300. When a large number of clients/attendees are participating in a collaborative computing session, the traffic within the network is greatly increased because each client/attendee receives a copy of the same data from the presenter/host through the server. Often, attendees may be connected to the session from a local intranet or through remote internet connections, such as being located behind a corporate firewall or gateway. As such, the same data for each attendee generally traverses the network from the servers (e.g., along the same path), thus redundantly utilizing network resources to that local intranet.

Data Distribution Efficiency Using Cascading Communication

According to embodiments of the disclosure, a server may distribute session data from a presenter device to a plurality of attendee devices, but to decrease the amount of traffic in the network, at least one of the plurality of attendee devices may be selected as a “super node,” where each super node is then responsible for one or more corresponding attendee devices of the session. The session data received at the super nodes may then be distributed from the super node to its one or more corresponding attendee devices, thus eliminating the need for excessive redundant data traversing the network to non-super nodes (“normal nodes”).

Illustratively, the techniques described herein may be performed by hardware, software, and/or firmware, such as in accordance with a cascading collaboration process 246, which may contain computer executable instructions executed by the processor 220 to perform functions relating to the novel techniques described herein, e.g., in conjunction with online collaborative computing process 245. In particular, cascading communication process 246 may be used to enhance the efficiency of online (e.g., real-time) collaboration traffic for collaborative computing sessions that have a large number of attendees, as described below.

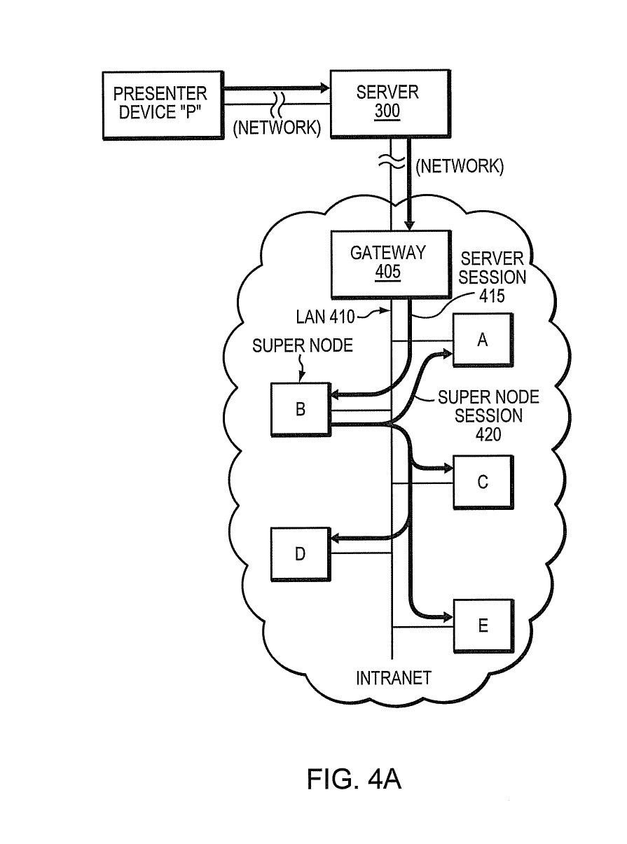

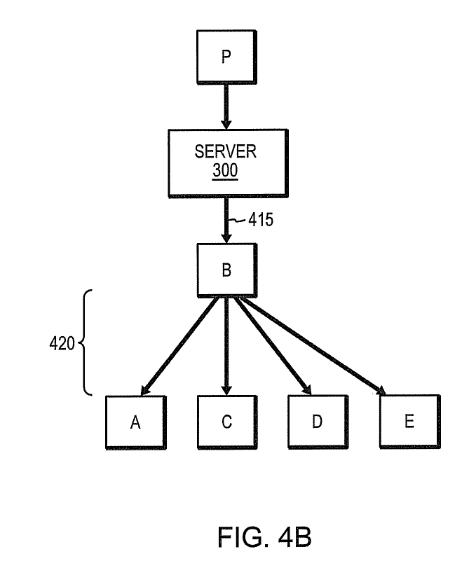

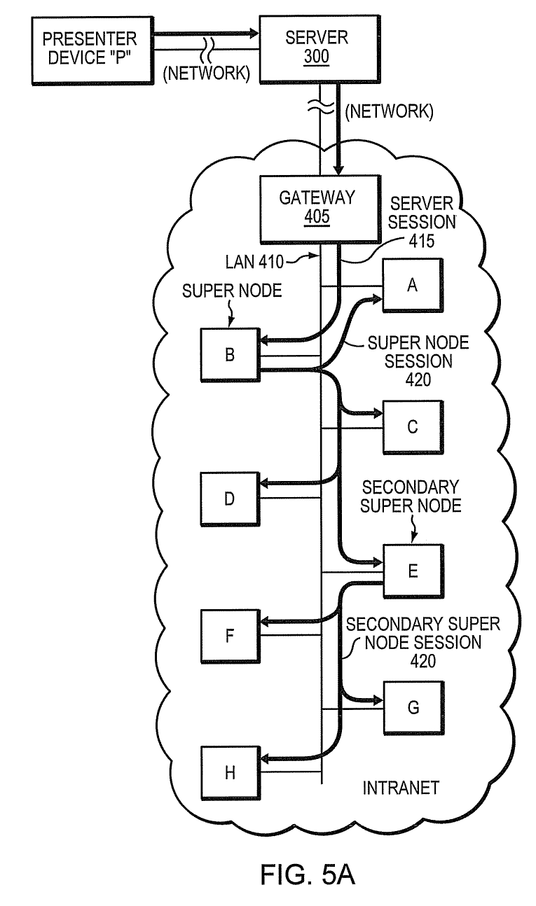

Operationally, an online collaborative computing session may be initiated between at least one presenter device and a plurality of attendee devices via a server 300. FIG. 4A illustrates an example and alternative view of a computer network comprising a plurality of participant devices 200, namely a presenter device “P” and a plurality of attendee devices “A-E,” which are located on a same intranet (e.g., LAN 410), as will be understood by those skilled in the art (e.g., determined by IP address prefix, etc.). Illustratively, the LAN is shown behind a gateway 405, but other known network devices may interconnect the LAN with the computer network (e.g., Internet/WAN), such as routers, switches, bridges, firewalls, etc.

Based on various factors, a cascading operation may be triggered for the online collaborative computing session to attempt to reduce network traffic outside of the LAN 410, and within the LAN (intranet/subnet), particularly the entry to the LAN (e.g., gateway). For instance, based on a number of attendee devices participating in the session (e.g., within a particular network or in general), the server 300 may initiate cascading to reduce network traffic (further described below). Other factors may also be used to trigger cascading collaboration, such as an amount of resources available to the online collaborative computing session (such as network bandwidth, etc.), or manual configuration, e.g., configuring the session (or all sessions, or all sessions to a particular network, etc.) to utilize cascading collaboration as defined herein. Notably, the decision to utilize cascading collaboration (manual or dynamic) may be executed at anytime during an online collaborative computing session, or prior to the establishment of the session (for manual configuration).

Upon determining that cascading collaboration is to be utilized, one or more super nodes are selected from potential attendee devices. Manual configuration may be used to select super nodes or to define super node candidates, such as by a particular subnet/company, and may be performed either during the session or through prior configuration (e.g., “attendee device A is always a super node candidate; attendee device E is never to be a super node,” etc.). Illustratively, however, one or more embodiments described herein allow for dynamic selection of the super nodes, such as through server selection or selection within a particular subnet/network (e.g., LAN 410). (Note that an attendee device or corresponding attendee/user may choose to either accept or deny the selection of the particular attendee device as a super node.)

For example, dynamic selection may be based on available resources (e.g., processor utilization, memory, bandwidth, etc.), manually configured super node candidacy, or other defined factors. When cascading collaboration is triggered, each attendee device (or a subset based on candidacy) may transmit a request to the server to become a super node for the session. In the event a plurality of attendee devices are competing to be selected as a super node, the super node (or nodes) may be selected based on most available (or best) resources, or simply on a first-come-first-serve basis. Also, the server may determine based on the number of requests (or the number of attendee devices, generally) how many super nodes should be selected. For instance, super node—to—normal node ratios may be established by the server or subnet/company, such that the number of super nodes is proportional to the number of attendee devices collaborating in the session. For example, if a ratio of 1:10 is defined, then for every 10 attendee devices (or normal nodes) there is one super node. Thus, the more attendee devices that join a session, the more super nodes may be selected. As shown in FIG. 4A, one example super node B has been selected.

Once a super node is selected, that super node (or the server) may confirm its selection with the server, and notify the other attendees of the session (e.g., within the subnet/company) that it is acting as a super node. For instance, for the other attendee devices this notification may then trigger a handshake with the notifying super node so that the attendee device may request to “join” the super node, i.e., become a corresponding attendee device (normal node) of the super node to receive the session data (e.g., normal nodes A and C-E). If the super node is overburdened, e.g., with too many other normal nodes, then that super node may decline the request, or may simply not respond, in which case another notifying super node may accept the normal node's request. If no response is received by the normal node, then the normal node may simply maintain a session with the server, or may request that it become a super node itself in case other attendee devices wish to join the session (or, for example, creating another competition, such as where twenty normal nodes have been declined, all or a subset of those twenty normal nodes may make subsequent attempts to become a super node, etc.).

A new attendee device joining a session may initially submit a broadcast request within the subnet/company to determine whether a super node exists for the session, thus asking whether any devices can be its super node. In response to determining that there is a willing super node, the new attendee device may join the corresponding super node session (e.g., based on a first-response basis). Again, if there is no response or a response indicating the absence of a super node, the new attendee device may request to become a super node itself, as above.

The one or more super nodes (e.g., super node B) may initiate/establish a corresponding super node session on which the session data is distributed (forwarded) to its corresponding attendee devices (normal nodes). In other words, the super node B receives session data 415 from the server 300 (which received the data from the presenter device P) directly, and then the corresponding normal nodes (A and C-E) simply receive a copy of the data from the super node session 420. FIG. 4B illustrates an alternative view of FIG. 4A, showing an hierarchical organization of the primary session 415 and any super node sessions 420.

Illustratively, normal nodes typically maintain their connection with the server (not shown), but simply do not receive any of the presenter's data from server on the server session 415. Accordingly, other session data (“attendee data”) may still be transmitted, such as session maintenance data, login or security data, etc., which are not originated by the presenter device. In particular, normal nodes send data directly back to the server without going through their super node (i.e., on the server session, not on the super node session), such that each individual attendee device may transmit attendee data to the server. The purpose of the super node session is to limit the redundant (and typically larger) traffic from the presenter device across the network to the subnet/intranet (and thus through the entry to the subnet/intranet and within the subnet/intranet), not to handle all independent communication between the server and each individual attendee device. Also, in the event a super node is removed from the network, it may be simpler to begin forwarding presenter device data on the existing server session to the corresponding normal nodes than to establish a new session (e.g., until a new super node is selected).

During the course of an online collaborative computing session, dynamically selected super nodes may be reselected, adjusted, added, removed, etc. based on a variety of factors. For instance, a super node may be dropped as a super node (thus becoming a normal node) if the available resources of the super node fall below an acceptable level. Alternatively, if an available option, an attendee may manually dictate that the corresponding attendee device no longer operate as a super node. In certain situations, the drop of available resources may be due to an increased number of attendee devices joining the online collaborative computing session.

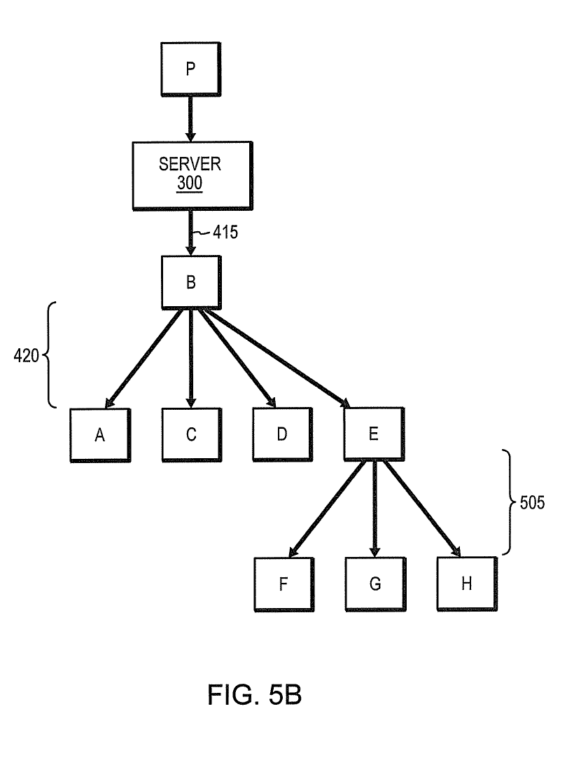

As shown in FIG. 5A, three illustrative attendee devices “F-H” may later join the session, and learn of super node B within their network. If super node B is unable to support the additional super node sessions (e.g., based on resources, a predetermined maximum number of corresponding normal nodes, or other factors), then an additional super node may be required. While one option is to select a new super node to have an established connection with the server 300, an alternative solution is to further cascade the communication. In other words, as shown in FIG. 5A, normal node E may be selected (as described above) to become a super node (e.g., a “secondary super node”) for the additional normal nodes F-H. In this manner, super node E receives the session data (420) from an upstream super node B, and transmits/forwards the session data to its corresponding normal nodes (secondary super node session 505). As further shown in FIG. 5B, the session organization now has multiple (hierarchical) levels of cascading communication. Notably, these levels may extend based on need/configuration, e.g., such that larger numbers of attendee devices do not burden the resources of only a few super nodes.

According to one or more embodiments described herein, the online collaborative computing session may comprise one or more “sub-sessions,” such as a different sub-session for various components of the session itself. As mentioned above, these sub-sessions may comprise voice, data, video, chat, file transfer, etc. In this particular instance, super nodes may be selected based on sub-session participation, where each sub-session has a corresponding super node. (Note that each sub-session should have at least one super node, but that super node may also be a super node for another sub-session.) Since each super node is a participant in the session that is to be distributed, then the super node may also be required to join (participate in) all of the sub-sessions.

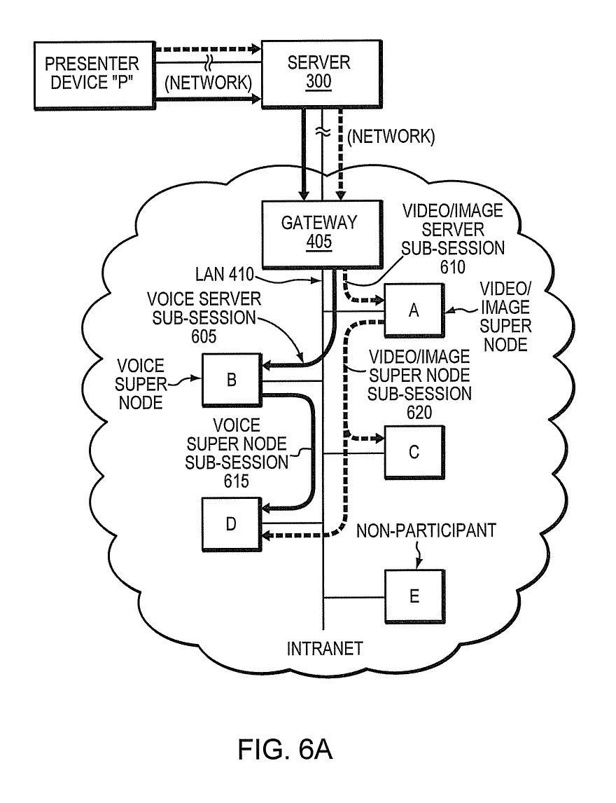

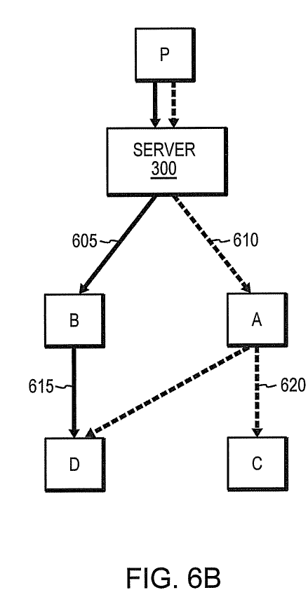

FIG. 6A illustrates an example of two sub-sessions, one for voice (605) and one for video/images (610). Per the example shown, super node B is only participating in the voice session, but not the video session. Accordingly, an additional (or alternate) super node may be selected, e.g., A, that is participating in the video session. In this manner, any normal nodes participating in the voice session will receive the voice transmission from super node B (e.g., normal node D from super node session 615), while any normal nodes participating in the video session will receive the video transmission from super node A (e.g., normal nodes D and C from super node session 620). Note that normal node D is participating in both sessions, and may seem like a better choice for a super node to participate in both sessions, however in certain circumstances, this may not be the case. For instance, node D may be a low-power/resource device, such as a PDA or older computer, and may not be suitable for use as a super node. Alternatively, it may be specifically configured (e.g., on server 300 or internal to the subnet/company) that each sub-session be handled by a different super node in order to balance responsibility among multiple devices. (Similar to FIGS. 4B and 5B, FIG. 6B further illustrates the example sub-session organization.)

It should also be noted that there may be different super nodes for different servers (e.g., for redundant or location specific servers, in addition to where a particular server corresponds to a particular sub-session), or for different geographic locations, as well. The example locations and selection criteria mentioned herein are merely examples, and are not meant to limit the scope of the embodiments described herein.

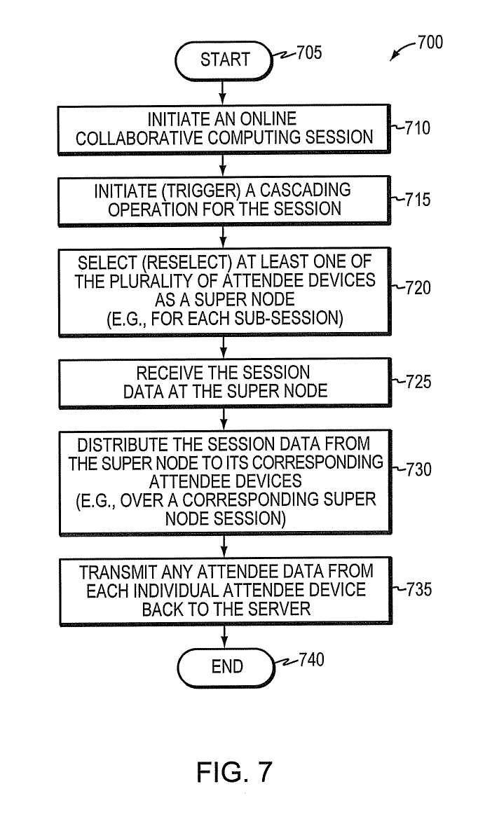

FIG. 7 illustrates a simplified example procedure for providing increased traffic efficiency for online collaborative computing sessions in accordance with one or more embodiments described herein. The procedure 700 starts at step 705, and continues to step 710, where an online collaborative computing session is established between one or more participating devices 200 via one or more servers 300. As described above, in step 715, a cascading operating for the session may be initiated (e.g., triggered) based on one or more factors, such as number of participants, manual configuration, resource usage, etc. As such, in step 720, at least one of the attendee devices of the session may be selected as a super node for the session (e.g., device B). For instance, as mentioned above, each sub-session may have a corresponding super node (e.g., devices A and B in FIG. 6A), or may share a single super node participating in each sub-session. Also, attendee devices may compete to be a super node, and/or may seek out any existing super nodes, detailed above.

The one or more super nodes may then receive the associated session data in step 725, and distributes the session data in step 730 to its corresponding attendee devices (e.g., from super node B to devices A and C-E in FIG. 4A), for example, over a corresponding super node session (or sub-session). Any attendee data from an individual attendee device may be transmitted back to the server 300 in step 735 directly, that is, not over a corresponding super node session, as described above. The procedure 700 ends in step 740, notably with the possibility of returning to step 720 to reselect super nodes based on various factors, e.g., device failure, device attendee leaving the session, limited resources, etc.

Advantageously, the novel techniques described herein provide increased traffic efficiency for online collaborative computing sessions in a computer network. By selecting one or more super nodes to be responsible for data distribution of a session to corresponding other attendee devices, the novel techniques decrease data traffic flow within the network during that session. In particular, the techniques described above reduce data congestion for large online collaborative computing sessions, particularly for an intranet/subnet having a single point of entry (e.g., gateway, router, etc.). For example, where each attendee device of an online collaborative computing session would normally receive 50 KBps for a session, having 1000 attendee devices in a network/subnet results in 50 MBps to that same subnet (50 KBps*1000=50 MBps). By using one super node in this subnet, the traffic may be reduced to nearly 50 KBps to that subnet, a substantial bandwidth and resource savings. (Even using ten super nodes results in reducing the traffic to 500 KBps.) Also, the dynamic aspects of one or more embodiments described herein alleviate the need for cumbersome and inefficient manual configuration.

While there have been shown and described illustrative embodiments that provide increased traffic efficiency for online collaborative computing sessions in a computer network, it is to be understood that various other adaptations and modifications may be made within the spirit and scope of the present invention. For example, the embodiments have been shown and described herein for use with online collaborative computing sessions. However, the embodiments of the invention in their broader sense are not so limited, and may, in fact, be used with any data distribution from a source device to a plurality of destination devices, where the super node is a destination device that receives the data for itself, and redistributes the data to other destination devices. (Notably, typical multicast or broadcast transmissions are different, in that the multicasting/broadcasting node is not a destination device, particularly for online collaborative computing sessions, e.g., an attendee device). Furthermore, although the sessions discussed in the text above have been described as “meeting” sessions, those sessions could be simply video, voice, or any other type of session in which session data is distributed from one node to one or more attendee devices.

The foregoing description has been directed to specific embodiments of this invention. It will be apparent, however, that other variations and modifications may be made to the described embodiments, with the attainment of some or all of their advantages. For instance, it is expressly contemplated that the components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method, comprising:
initiating an online collaborative computing session by a server between a presenter device and a plurality of attendee devices to distribute session data from the presenter device to the plurality of attendee devices via the server;
selecting at least one of the plurality of attendee devices as a super node, each super node responsible for one or more corresponding attendee devices of the session;
receiving the session data at the super node; and
distributing the session data from the super node to the one or more corresponding attendee devices of that super node.

2. The method as in claim 1, further comprising:
initiating, by the server, a cascading operation for the online collaborative computing session, wherein the selecting of the super node and distributing the session data to the corresponding attendee devices of the super node is in response to the cascading operation.

3. The method as in claim 2, further comprising:
triggering the initiating of the cascading operation based on a number of attendee devices participating in the session.

4. The method as in claim 2, further comprising:
triggering the initiating of the cascading operation based on resources available to the online collaborative computing session.

5. The method as in claim 2, further comprising:
initiating the cascading operation during the online collaborative computing session.

6. The method as in claim 1, further comprising:
reselecting the super node during the online collaborative computing session.

7. The method as in claim 1, further comprising:
competing by one or more of the plurality of attendee devices to be selected as a super node.

8. The method as in claim 7, wherein selecting comprises:
selecting the super node from the competing attendee devices based on a first-come-first-serve basis.

9. The method as in claim 7, wherein selecting comprises:
selecting the super node from the competing attendee devices based on resources of the competing attendee devices.

10. The method as in claim 1, wherein selecting comprises:
selecting the super node based on a manual configuration.

11. The method as in claim 1, further comprising:
transmitting attendee data from each individual attendee device to the server.

12. The method as in claim 1, wherein the super node distributes session data to corresponding attendee devices within a Local Area Network.

13. The method as in claim 1, wherein the online collaborative computing session comprises one or more sub-sessions, the selecting further comprising selecting at least one super node for each sub-session.

14. The method as in claim 13, further comprising:
requiring a selected super node for a particular sub-session participate in that particular sub-session.

15. The method as in claim 1, further comprising:
initiating, for each super node, a corresponding super node session on which the session data is distributed to the corresponding attendee device from each respective super node, wherein the corresponding attendee device maintains an original session with the server.

16. The method as in claim 1, further comprising:
choosing by a particular attendee device to either accept or deny the selection of the particular attendee device as a super node.

17. The method as in claim 1, further comprising:
joining the session by an attendee device;
determining by the joining attendee device whether a super node exists for the session; and
in response to determining that there is a super node, joining a corresponding session of existing super node.

18. The method as in claim 1, further comprising:
requesting to be selected as a super node for the session.

19. An apparatus, comprising:
one or more network interfaces adapted to transmit and receive data on a computer network;
a processor coupled to the network interfaces and adapted to execute one or more processes; and
a memory configured to store a cascading collaboration process executable by the processor, the cascading collaboration process when executed operable to:
join an online collaborative computing session, the session initiated by a server between a presenter device and a plurality of attendee devices to distribute session data from the presenter device to the plurality of attendee devices via the server,
determine that the apparatus is selected as a super node from the plurality of attendee devices,
determine that the apparatus is responsible for one or more corresponding attendee devices of the session,
receive the session data, and
distribute the session data to the one or more corresponding attendee devices.

20. A tangible computer-readable media having software encoded thereon, the software when executed on a device operable to:
join an online collaborative computing session, the session initiated by a server between a presenter device and a plurality of attendee devices to distribute session data from the presenter device to the plurality of attendee devices via the server,
determine that the device is selected as a super node from the plurality of attendee devices,
determine that the device is responsible for one or more corresponding attendee devices of the session,
receive the session data, and
distribute the session data to the one or more corresponding attendee devices.
